(19) United States
(12) Patent Application Publication
(10) Pub. No.: US 2004/0108066 A1
(43) Pub. Date: Jun. 10, 2004

(54) Temperature measuring method and plasma processing apparatus

(75) Inventors: Toshihiro Hayami, Nirasaki-shi (JP); Shosuke Endoh, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 10/724,693

(22) Filed: Dec. 2, 2003

(30) Foreign Application Priority Data
Dec. 3, 2002 (JP) 2002-351314

(51) Int. Cl. H05H 1/00

(52) U.S. Cl. 156/345.27

(57) ABSTRACT

A temperature measurement opening 30 is formed in a bottom portion of a process vessel 1 of a plasma etching apparatus, the temperature measurement opening 30 having a size not allowing a radio frequency power with a high frequency applied on a susceptor 2 to leak outside. To an external side of the temperature measurement opening 30, a radiation thermometer 31 is attached. The radiation thermometer 31 detects an infrared ray 35 emitted from the inside of a temperature measurement hole 32 formed on a rear face side of the susceptor 2 to measure the temperature of the susceptor 2.

### CROSS REFERENCE TO THE INVENTION

This application is based upon and claims the benefit of priority from the prior Japanese Patent Application No. 2002-351314, filed on Dec. 3, 2002; the entire contents of which are incorporated herein by reference.

### BACKGROUND OF THE INVENTION

1. Field of the Invention

The present invention relates to a temperature measuring method of measuring the temperature of, for example, a susceptor or the like disposed in a process vessel of a plasma processing apparatus and to the plasma processing apparatus.

2. Description of the Related Art

In a semiconductor fabrication process and so on, a predetermined process has been conventionally applied on a substrate to be processed such as a semiconductor wafer in such a manner that a plasma is generated by a radio frequency power in a conductive vessel in which a space for the generation of the plasma therein is formed, and this plasma is made to act on the substrate to be processed.

A parallel electrodes type plasma etching apparatus for etching a semiconductor wafer is an example of such an apparatus. As shown in FIG. 4, the parallel electrodes type plasma etching apparatus includes a process vessel 1 constituted of a conductive vessel using a conductive material such as, for example, aluminum whose surface is anodized. In the process vessel 1, a susceptor 2 also serving as a bottom electrode is provided and a top electrode 3 is disposed to face this susceptor (bottom electrode) 2.

A predetermined process gas is supplied from a process gas supply system 4 via a large number of pinholes 5 formed in the top electrode 3. At the same time, a radio frequency power source 6 applies a radio frequency power with a predetermined frequency on the susceptor 2 via a matching device 7 to generate a plasma of the treatment gas. This plasma is made to act on a semiconductor wafer W placed on the susceptor 2 to apply a predetermined etching process on the semiconductor wafer W.

An exhaust system 8 is connected to a bottom portion of the process vessel 1. The inside of the process vessel 1 is exhausted by this exhaust system 8 via an exhaust ring 10 provided along the periphery of the susceptor 2 and having a large number of transparent holes 9 formed thereon.

Further, an electrostatic chuck is formed on an upper face of the susceptor 2. A predetermined direct-current voltage is applied on an electrode 11 of this electrostatic chuck from a direct-current power source 12, so that the semiconductor wafer W is held by suction by a Coulomb force or the like. A focus ring 13 in a ring shape is further provided to surround the periphery of the semiconductor wafer W placed on the susceptor 2.

Outside a sidewall portion of the process vessel 1, a magnetic field generating mechanism 14 in a ring shape is provided. The magnetic field generating mechanism 14 is intended for generating a magnetic field in the process vessel 1 to control the plasma. This magnetic field generating mechanism 14 includes a rotation mechanism 15. This rotation mechanism 15 enables the magnetic field generating mechanism 14 to rotate around the process vessel 1.

Note that in the drawing, 16 denotes an insulative support member for supporting the susceptor 2 in an electrically insulated state from the process vessel 1, and 17 denotes a feeding rod through which the radio frequency power is applied on the susceptor 2.

When the semiconductor wafer W is subjected to the etching process or the like in the plasma etching apparatus as described above, the temperature of the semiconductor wafer W increases since it is exposed to the plasma. Therefore, the susceptor 2 has a not-shown temperature control mechanism that controls the temperature by, for example, circulating a refrigerant or the like. This temperature control mechanism controls the temperature of the susceptor 2 at a predetermined value to indirectly control the temperature of the semiconductor wafer W.

For the temperature control by the temperature control mechanism described above, the susceptor 2 also has a temperature sensor 20 for measuring the temperature of the susceptor 2. This temperature sensor 20 is constituted of, for example, a Pt sensor, a TC sensor, or the like. As shown in FIG. 5, a tip portion of the temperature sensor 20 is inserted in a mounting hole 21 formed by perforating a rear face side of the susceptor 2.

In a case when the temperature sensor 20 as described above is provided, this temperature sensor 20 and a signal line 22 for leading out a detection signal from this temperature sensor 20 have to be disposed in the process vessel 1 in which a radio-frequency electric field is formed. Therefore, a sheath type sensor is used in which the signal line 22 and so on are covered with a sheath 23 connected to the process vessel 1 which is set to a ground potential. The use of the sheath type sensor prevents the radio frequency power from leaking outside and from giving an influence to a temperature detection signal.

The susceptor 2 is formed of a conductive material such as aluminum since it also serves as the bottom electrode. This makes it necessary to electrically insulate the susceptor 2 from the temperature sensor 20. For this purpose, an insulative member 24 is disposed in a portion where the susceptor 2 and the temperature sensor 20 are in contact with each other. The insulative member 24 is in a cylindrical shape and is made of an insulative material (for example, BN or the like) which is relatively high in heat conduction and low in dielectric loss.

However, since the radio frequency power is applied on the susceptor 2, capacitance coupling via the aforesaid insulative member 24 is formed between the conductive susceptor 2 and the temperature sensor 20. This capacitance coupling may possibly cause damage to the temperature sensor 20 and the sheath 23 due to the passage of an electric current therethrough. In addition, high-precision temperature measurement of the susceptor 2 may possibly be hindered by dielectric heating of the insulative member 24. Therefore, in practice, the insulative member 24 is formed to be thick enough to avoid such a problem.

In recent years, the frequency of the radio frequency power used for the plasma processing has been on the increase. For example, a radio frequency power with a high frequency such as 40 MHz, 60 MHz, or further 100 MHz has come into use in place of a conventionally used frequency of 13.56 Hz.

Consequently, the impedance of the aforesaid capacitance coupling is lowered and a sufficient insulating property cannot be ensured unless the thickness of the insulative member 24 is further increased. For example, when a cylindrical member (BN) that is 6 mm in outside diameter and 30 mm in length is used as the insulative member 24 and a hole that is 1.7 mm in diameter and 28 mm in depth is formed in this cylindrical member as a hole for allowing the temperature sensor 20 to be inserted therein, electric properties are as follows.

(when the frequency of the radio frequency
power is 13.56 MHZ)

| | | |
|---|---|---|
| capacitance = | 8.3 | pF |
| impedance = | 1407 | Ω |
| inflow current when a voltage with 1 KV Vpp is applied = | 0.51 | A |
| dielectric heating when a voltage with 2 KV Vpp is applied = | 0.07 | W |

(when the frequency of the radio frequency
power is 100 MHZ)

| | | |
|---|---|---|
| capacitance = | 8.3 | pF |
| impedance = | 191 | Ω |
| inflow current when a voltage with 1 KV Vpp is applied = | 3.74 | A |
| dielectric heating when a voltage with 2 KV Vpp is applied = | 0.53 | W |

However, the increase in thickness of the insulative member 24 causes such a problem that high-precision temperature measurement is not possible. This is because, due to a low heat conductivity of the insulative member 24 compared with that of metal, the temperature of the insulative member 24 becomes different from that of the susceptor 2 and the response speed to the temperature change of the susceptor 2 becomes lower.

The impedance that a plasma has is generally, for example, about 10 Ω to 50 Ω. Therefore, the above-mentioned problem is made especially distinguished in the use of a high frequency of about 40 MHz or higher at which the insulative member 24 cannot have a sufficiently large impedance compared with the impedance that the plasma has.

The following temperature measuring methods are available in processes other than the above-described plasma processing using the radio frequency power. For example, in a process of film growth through a vapor phase chemical reaction by heating a substrate, a method of measuring the temperature of the substrate or a susceptor surface by a radiation thermometer via a light incident window is available (see Japanese Patent Laid-open Application No. Hei 6-2147). Further, for example, in a heating process for curing photoresist with which the surface is coated, available is a method of measuring the temperature of an unprocessed semiconductor wafer placed on a hotplate by detecting a light reflected from the surface thereof (see Japanese Patent Laid-open Application No. 2001-4452).

However, it is difficult to directly apply the method of measuring the temperature of a semiconductor wafer or a susceptor in the above-described manner to the etching process or the like using the plasma. This is because a radio frequency power leaks from a window portion in which a transparent member is inserted and a light from the plasma becomes a noise. Further, the temperature in the actual course of the process cannot be measured precisely by the method of measuring the temperature in advance through the use of an unprocessed semiconductor wafer.

As described above, the plasma processing using the radio frequency power has such a problem that it does not allow precise temperature measurement. The increasing use of the radio frequency power with a higher frequency makes this problem more serious.

### SUMMARY OF THE INVENTION

It is an object of the present invention to provide a temperature measuring method and a plasma processing apparatus in which the temperature of a susceptor can be measured with high precision and a satisfactory process can be applied even when a radio frequency power with a high frequency is used.

A temperature measuring method of the present invention is a temperature measuring method of measuring a temperature of a susceptor which is disposed in a conductive vessel and on which a substrate to be processed is to be placed, the vessel being set to a ground potential and having a space formed therein in which a plasma is generated by application of a radio frequency power, the method including: forming an opening in a portion of the conductive vessel facing a predetermined temperature measured portion on a rear face side of the susceptor, the opening having a size not allowing the radio frequency power to leak to an external part; and detecting, at an external part of the opening, an infrared ray emitted from the temperature measured portion to measure the temperature of the susceptor by a radiation thermometer.

A temperature measuring method of the present invention is characterized in that a diameter of the opening is set to 1/50 of a wavelength of the radio frequency power or smaller.

A temperature measuring method of the present invention is characterized in that a frequency of the radio frequency power is 40 MHz or higher.

A temperature measuring method of the present invention is characterized in that the temperature measured portion of the susceptor has a shape recessed toward a face on which the substrate to be processed is to be placed.

A temperature measuring method of the present invention is characterized in that the temperature measured portion of the susceptor is structured to act as a blackbody to the infrared ray.

A plasma processing apparatus of the present invention is a plasma processing apparatus including: a conductive vessel being set to a ground potential and having a space formed therein in which a plasma is generated by application of a radio frequency power; and a susceptor which is disposed in the conductive vessel and on which a substrate to be processed is to be placed, the plasma processor characterized in that the conductive vessel has an opening that is formed in a portion facing a predetermined temperature measured portion on a rear face side of the susceptor and that has a size not allowing the radio frequency power to leak to an external part, and a radiation thermometer detects, at an external part of the opening, an infrared ray emitted from the temperature measured portion to measure a temperature of the susceptor.

A plasma processing apparatus of the present invention is characterized in that a diameter of the opening is set to 1/50 of a wavelength of the radio frequency power or smaller.

A plasma processing apparatus of the present invention is characterized in that a frequency of the radio frequency power is 40 MHz or higher.

A plasma processing apparatus of the present invention is characterized in that the temperature measured portion of the susceptor has a shape recessed toward a face on which the substrate to be processed is to be placed.

A plasma processing apparatus of the present invention is characterized in that the temperature measured portion of the susceptor is structured to act as a blackbody to the infrared ray.

### BRIEF DESCRIPTION OF THE DRAWINGS

FIG. 1 is a view showing a schematic configuration of a plasma processing apparatus according to an embodiment of the present invention.

FIG. 2 is a view showing a schematic configuration of an essential part of the plasma processing apparatus shown in FIG. 1.

FIG. 3 is a view showing an example of a temperature measurement signal in the plasma processing apparatus shown in FIG. 1.

FIG. 4 is a view showing a schematic configuration of a conventional plasma processing apparatus.

FIG. 5 is a view showing a schematic configuration of an essential part of the plasma processing apparatus shown in FIG. 4.

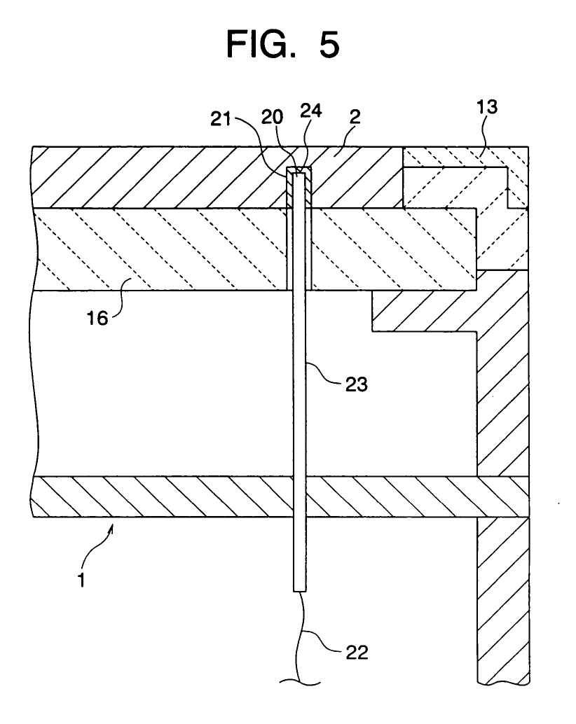

### DESCRIPTION OF THE EMBODIMENTS

Hereinafter, an embodiment of the present invention will be explained in detail with reference to the drawings.

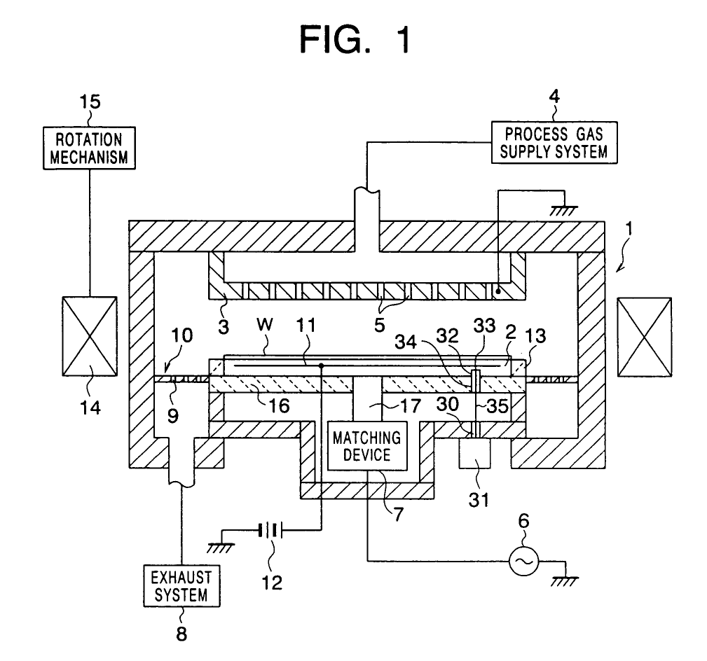

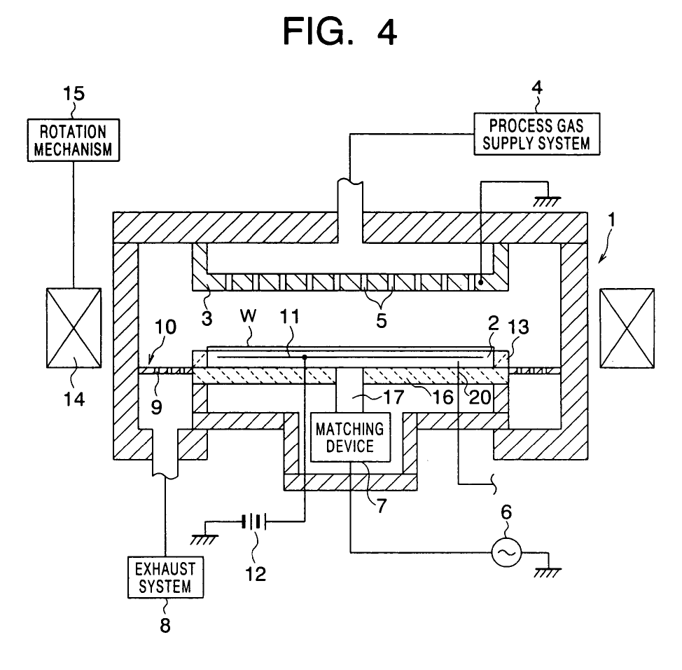

FIG. 1 schematically shows a general configuration of an entire plasma etching apparatus as a plasma processing apparatus according to an embodiment of the present invention. In FIG. 1, the same reference numerals are used to designate portions corresponding to those in the above-described plasma etching apparatus shown in FIG. 4.

In the plasma etching apparatus of this embodiment, a process vessel 1 is constituted of a conductive vessel using a conductive material such as, for example, aluminum whose surface is anodized. In the process vessel 1, a susceptor 2 also serving as a bottom electrode and a top electrode 3 facing this susceptor (bottom electrode) 2 are provided. This process vessel 1 is set to a ground potential and is designed so that a radio frequency power does not leak to an external part of the process vessel 1 when an etching process or the like is performed by applying the radio frequency power with a predetermined frequency (for example, 40 MHz to 100 MHz) on the susceptor 2 from a radio frequency power source 6.

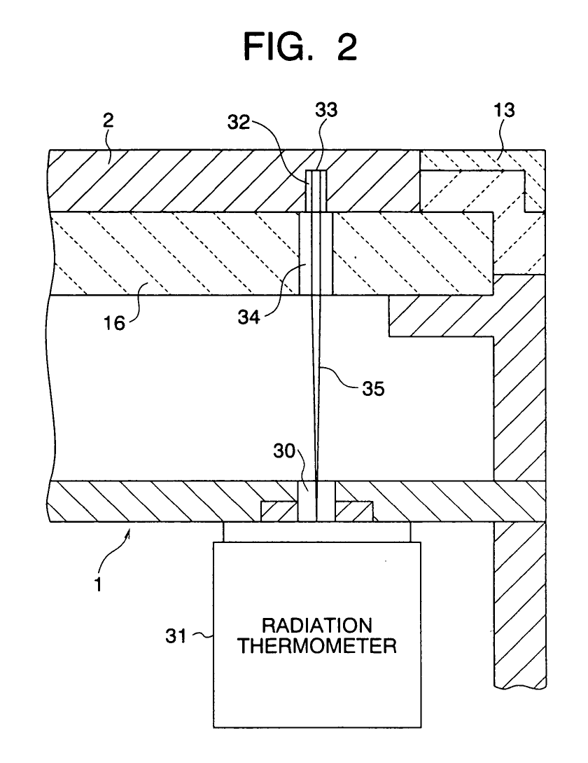

Further, as shown also in FIG. 2, the process vessel 1 has on its bottom portion a temperature measurement opening 30 for allowing the measurement of the temperature of the susceptor 2 from a rear face side of the susceptor 2. A radiation thermometer 31 for calculating the temperature from the intensity of an infrared ray with a predetermined wavelength is attached to an external side of this temperature measurement opening 30.

A portion of the susceptor 2 positioned above the temperature measurement opening 30 is a temperature measured portion. In this temperature measured portion, a temperature measurement hole 32 is formed so that the temperature measured portion becomes in a shape recessed toward a face on which a wafer W is to be placed, which allows the detection of the temperature of a portion as close as possible to an upper face of the susceptor 2 on which the wafer W is placed. On a top portion 33 in this temperature measurement hole 32, a treatment to make the top portion 33 act as a blackbody (blackbody treatment) is applied, such as pasting of a blackbody tape or coating of a blackbody paint.

Here, the blackbody is a substance having a high emissivity in a region of an infrared ray detected by the radiation thermometer 31, and the blackbody treatment is a treatment to impart a function as a blackbody, which does not necessarily appear black in a visible light range.

When the susceptor 2 is made of aluminum, the anodization (for example, 50 μm sulfuric acid hard anodized aluminum) of the top portion 33 of the temperature measurement hole 32 can impart this portion with a sufficient function as the black body.

An insulative support member 16 for supporting the susceptor 2 has a transparent hole 34 formed therein that is slightly larger in diameter than the aforesaid temperature measurement hole 32. The radiation thermometer 31 detects an infrared ray 35 emitted from the inside of the temperature measurement hole 32 via the transparent hole 34 so that the temperature of the susceptor 2 can be measured.

As previously described, the process vessel 1 is constituted of the conductive vessel using the conductive material such as aluminum entirely anodized, and is set to the ground potential, thereby preventing the radio frequency power from leaking outside. Therefore, it is necessary to prevent the radio frequency power from leaking outside from the aforesaid temperature measurement opening 30. For this purpose, the temperature measurement opening 30 is formed to have an opening diameter of 1/50 or smaller of a wavelength of the radio frequency power which is applied on the susceptor 2 from the radio frequency power source 6.

When the frequency of the radio frequency power applied on the susceptor 2 from the radio frequency power source 6 is, for example, 100 MHz, its wavelength is about 300 cm. In this case, the opening diameter of the temperature measurement opening 30 is set to about 6 cm or smaller. Incidentally, the opening diameter of the temperature measurement opening 30 is set to about 10 mm in this embodiment.

As mentioned above, when the opening diameter of the temperature measurement opening 30 is set to 1/50 or smaller of the wavelength of the radio frequency power in use, the radio frequency power is prevented from leaking outside from the temperature measurement opening 30. Note that this temperature measurement opening 30 is not intended for drawing out, for example, a cable, an optical fiber, or the like for electric signals therethrough, but only forms an opening.

This is because the radio frequency power easily leaks if a cable, an optical fiber, or the like for electrical signals is drawn out through such an opening. Further, if a transparent window member or the like for closing such an opening is provided, the leakage of the radio frequency is also easily caused. Therefore, it is also preferable not to provide such a member. In the plasma etching apparatus of this embodiment, a transparent window member or the like needs not be provided for airtightness, sealing, or other purposes since the rear face side of the susceptor 2 is set to an atmospheric pressure atmosphere.

In the plasma etching apparatus as configured above, the radiation thermometer 31 provided outside the process vessel 1 detects, through the temperature measurement opening 30 which is set to the size not allowing the leakage of the radio frequency power to the external part, the infrared ray emitted from the inside of the temperature measurement hole 32 provided on the rear face side of the susceptor 2, thereby measuring the temperature of the susceptor 2.

This structure makes it possible to measure the temperature of the rear face side of the susceptor 2 more directly without any insulative member or the like being interposed between the radiation thermometer 31 and the temperature measured portion of the susceptor 2, which allows a high-precision detection of the temperature of the susceptor 2. Further, since no sensor, signal line, or the like is disposed inside the process vessel 1, there occurs no noise which might be caused when a component of the radio frequency power applied on the susceptor 2 should be superimposed on a measurement signal or the like.

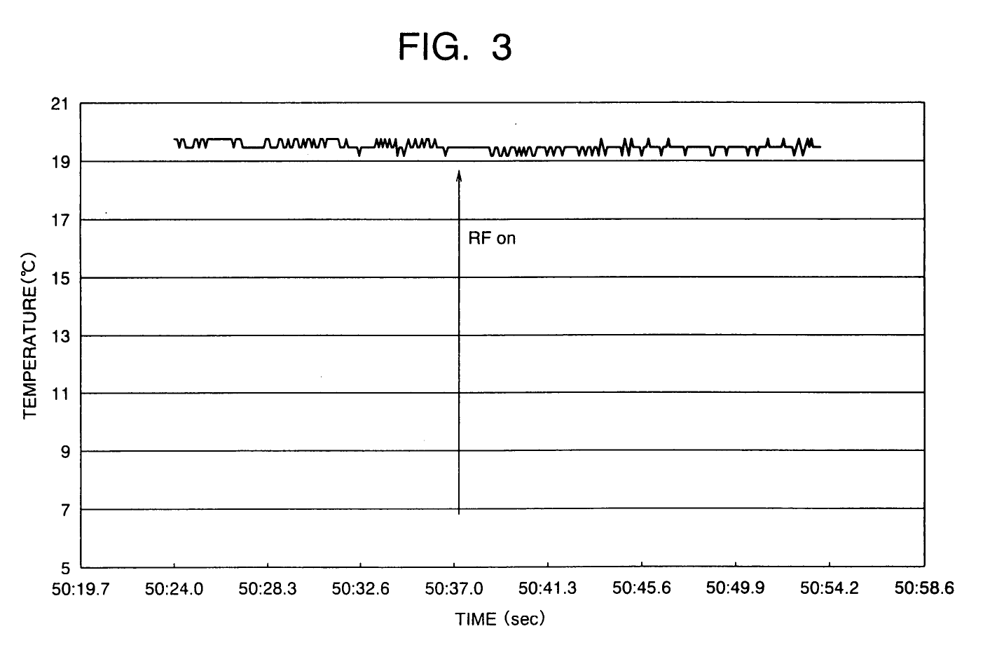

FIG. 3 shows how the temperature measurement signal from the radiation thermometer 31 varies with time in the above-described plasma etching apparatus. As shown in the drawing, no noticeable variation is observed in the temperature measurement signal from the radiation thermometer 31 before and after an instant at which the radio frequency power is applied on the susceptor 2 (shown by the arrow RF on in the drawing). This shows that the component of the radio frequency power has no influence to the measurement signal even when the radio frequency power is applied.

Further, in this embodiment, the blackbody treatment is applied on the top portion 33 in the temperature measurement hole 32, which makes it possible to measure the temperature of the susceptor 2 with an increased precision.

Next, the procedure of a plasma etching process by the plasma etching apparatus as configured above will be explained.

First, a not-shown gate valve provided in the process vessel 1 is opened, and a semiconductor wafer W is carried into the process vessel 1 by a transfer mechanism (not shown) via a load lock chamber (not shown) disposed adjacent to this gate valve and is placed on the susceptor 2. Then, after the transfer mechanism is made to retreat outside the process vessel 1, the gate valve is closed. At the same time, a direct-current voltage at a predetermined voltage is applied on an electrode 11 of an electrostatic chuck from a direct-current power source 12, so that the semiconductor wafer W is held by suction.

Thereafter, a predetermined process gas is supplied into the process vessel 1 from a process gas supply system 4 while the inside of the process vessel 1 is being exhausted by a vacuum pump of an exhaust system 8 to a predetermined vacuum degree, for example, 1.33 Pa to 133 Pa.

Then, in this state, a radio frequency power with a predetermined frequency, for example, 40 MHz to 100 MHz is applied on the susceptor 2 from the radio frequency power source 6 via a matching device 7 to generate a plasma in a space between the susceptor 2 and the top electrode 3, and the semiconductor wafer W is plasma-etched.

In plasma-etching the semiconductor wafer W as described above, the radiation thermometer 31 measures the temperature of the susceptor 2, and a not-shown temperature control mechanism controls the temperature of the susceptor 2. In this temperature control, the temperature of the susceptor 2 can be controlled to a predetermined value with high precision since the radiation thermometer 31 can measure the precise temperature of the susceptor 2 as previously described. Therefore, a satisfactory etching process can be applied on the semiconductor wafer W while it is kept at a predetermined temperature.

Then, after a predetermined etching process has been executed, the supply of the radio frequency power from the radio frequency power source 6 is stopped to stop the etching process, and the semiconductor wafer W is carried out of the process vessel 1 in a reverse procedure to the above-described procedure.

In the above-describe embodiment, the case when the present invention is applied to the plasma etching of the semiconductor wafer W is explained. However, the present invention is not limited to such an embodiment, and is of course applicable to any kind of plasma processing of any object to be processed.

As is explained hitherto, according to the temperature measuring method and the plasma processing apparatus of the present invention, it is possible to measure the temperature of a susceptor with high precision even when a radio frequency power with a high frequency is used, which makes it possible to realize a satisfactory process.

What is claimed is:

1. A temperature measuring method of measuring a temperature of a susceptor which is disposed in a conductive vessel and on which a substrate to be processed is to be placed, the conductive vessel being set to a ground potential and having a space formed therein in which a plasma is generated by application of a radio frequency power, the method comprising:
forming an opening in a portion of the conductive vessel facing a predetermined temperature measured portion on a rear face side of the susceptor, the opening having a size not allowing the radio frequency power to leak to an external part; and
detecting, at an external part of the opening, an infrared ray emitted from the temperature measured portion to measure the temperature of the susceptor by a radiation thermometer.

2. A temperature measuring method as set forth in claim 1,
wherein a diameter of the opening is set to 1/50 of a wavelength of the radio frequency power or smaller.

3. A temperature measuring method as set forth in claim 1,
wherein a frequency of the radio frequency power is 40 MHz or higher.

4. A temperature measuring method as set forth in claim 1,
wherein the temperature measured portion of the susceptor has a shape recessed toward a face on which the substrate to be processed is to be placed.

5. A temperature measuring method as set forth in claim 1,
wherein the temperature measured portion of the susceptor is structured to act as a blackbody to the infrared ray.

6. A plasma processing apparatus comprising:
a conductive vessel being set to a ground potential and having a space formed therein in which a plasma is generated by application of a radio frequency power; and
a susceptor which is disposed in said conductive vessel and on which a substrate to be processed is to be placed,
wherein said conductive vessel has an opening that is formed in a portion facing a predetermined temperature measured portion on a rear face side of said susceptor and that has a size not allowing the radio frequency power to leak to an external part, and a radiation thermometer detects, at an external part of the opening, an infrared ray emitted from the temperature measured portion to measure a temperature of said susceptor.

7. A plasma processing apparatus as set forth in claim 6,
wherein a diameter of the opening is set to 1/50 of a wavelength of the radio frequency power or smaller.

8. A plasma processing apparatus as set forth in claim 6,
wherein a frequency of the radio frequency power is 40 MHz or higher.

9. A plasma processing apparatus as set forth in claim 6,
wherein the temperature measured portion of said susceptor has a shape recessed toward a face on which the substrate to be processed is to be placed.

10. A plasma processing apparatus as set forth in claim 6,
wherein the temperature measured portion of said susceptor is structured to act as a blackbody to the infrared ray.
